(19) United States
(12) Patent Application Publication
(10) Pub. No.: US 2021/0303536 A1
(43) Pub. Date: Sep. 30, 2021

(54) METHODS AND SYSTEMS FOR GRAPH APPROXIMATION

(71) Applicant: NEC Laboratories Europe GmbH, Heidelberg (DE)

(72) Inventors: Francesco Alesiani, Heidelberg (DE); Shujian Yu, Heidelberg (DE)

(21) Appl. No.: 16/823,455

(22) Filed: Mar. 19, 2020

(51) Int. Cl. G06F 16/22; G06F 16/23

(52) U.S. Cl. CPC G06F 16/2264; G06F 16/23

(57) ABSTRACT

Systems and methods for graph approximation include computing an incident matrix based on an original graph, defining a cost function of a new graph, the cost function including an entropy of the new graph, a graph distance and a number of edges and/or nodes, wherein the graph distance includes a value representing a distance between the new graph and the original graph, determining a reduced cost function by, iteratively: a) computing a gradient of the cost function for the new graph, and b) modifying the new graph by adding an edge to, or removing an edge from, the new graph; and outputting an approximated graph, the approximated graph corresponding to the modified new graph having a minimum of the cost function.

### FIELD

Embodiments relate to methods and systems for graph approximation and graph sparsification.

### BACKGROUND

Graph sparsification is the problem of reducing the number of nodes or edges in a graph, where a graph is defined as a set of nodes, edges that connect two nodes and attributes on the edges and on the nodes. Graph approximation is the concept of altering a current graph in order to approximate with another graph that has some different properties, while retaining other properties. Sparsification is graph approximation with fewer number of edges or nodes; graph sparsification is sometimes referred as graph coarsening.

Graphs are present in many areas and can be used to model various problems. The reduction in size of a graph is helpful for computational reasons but also for improving generalization; indeed, some edges in a graph may not represent correct relationships and should be removed. Removing edges alters the properties of the graph.

The most extreme form of graph sparsification is the Minimum Spanning Tree (MST) where only N−1 edges are maintained, where N is the number of nodes. METIS is another algorithm for graph coarsening based on MST. Another important way to sparsify a graph is based on the Effective Resistance, which produces a graph of multiplicative approximation of the original graph. Another class of methods relies on heuristics and does not have an explicit cost function definition. The extreme case is a random algorithm, where edges are removed randomly from the graph.

These methods are not flexible in the sense that they do not allow to modify the end results of the sparsification if not in the final number of remaining edges.

### SUMMARY

The present invention provides a method for graph approximation, the method comprising: computing an incident matrix based on an original graph; defining a cost function of a new graph, the cost function including an entropy of the new graph, a graph distance and a number of edges and/or nodes, wherein the graph distance is a value representing a distance between the new graph and the original graph; determining a reduced cost function by, iteratively: computing a gradient of the cost function for the new graph, and modifying the new graph by adding an edge to, or removing an edge from, the new graph; and outputting an approximated graph, the approximated graph corresponding to the modified new graph having a minimum of the cost function.

### BRIEF DESCRIPTION OF THE DRAWINGS

Embodiments of the present invention will be described in even greater detail below based on the exemplary figures. The invention is not limited to the exemplary embodiments. All features described and/or illustrated herein can be used alone or combined in different combinations in embodiments of the invention. The features and advantages of various embodiments will become apparent by reading the following detailed description with reference to the attached drawings which illustrate the following:

FIG. 1 illustrates a graph approximation process according to an embodiment;

FIG. 2 illustrates a graph completion process according to an embodiment;

FIG. 3 illustrates a graph clustering process according to an embodiment;

FIG. 4 illustrates an embodiment of Regression with Graph Smoothing according to an embodiment;

FIG. 5 illustrates an embodiment of graph matching according to an embodiment;

FIG. 6 illustrates an embodiment of Multi-task Learning with a Graph Regularization; and

FIG. 7 is a block diagram of a processing system according to an embodiment.

### DETAILED DESCRIPTION

Embodiments of the present invention provide graph approximation systems and methods that provide an approximation based on a target number of retained edges and a parameter measuring the trade-off between the complexity of the resulting graph and the fidelity of the resulting graph to the original graph. Graphs capture relationship abound elements and their use is present in various Machine Learning applications. The various embodiments provide ways to approximate a graph based on a gradient descent method of graph entropy. The graph entropy describes the complexity or information associated with a graph. The embodiments improve the final prediction accuracy for various applications and advantageously reduce the computational complexity of existing Graph Base Learning Methods.

According to an embodiment, a method is provided that reduces the number of edges or/and nodes based on the gradient of the entropy of the graph, where the entropy of the graph is based on a matrix formulation, e.g., a Laplacian Matrix or a quadratic matrix, and is a function of the incident/original matrix.

According to an embodiment, a method for graph approximation is provided that includes computing or defining an incident matrix based on an original graph, defining a cost function of a new graph, the cost function including an entropy of the new graph, a graph distance and a number of edges and/or nodes, wherein the graph distance is a value representing a distance between the new graph and the original graph, determining a reduced cost function by, iteratively: a) computing a gradient of the cost function for the new graph, and b) modifying the new graph by adding an edge to, or removing an edge from, the new graph, and outputting an approximated graph, the approximated graph corresponding to the modified new graph having a minimum of the cost function.

According to an embodiment, the new graph is initially defined as a zero graph. According to an embodiment, the modifying includes adding an edge to the new graph.

According to an embodiment, the new graph is initially defined as the original graph. According to an embodiment, the modifying includes removing an edge from the new graph.

According to an embodiment, the new graph is initially defined as one of a MST graph, an Effective Resistance graph and a METIS graph.

According to an embodiment, the entropy of the new graph is one of a Laplacian Matrix based graph entropy, a Quadratic Matrix based graph entropy, and a feature-based Laplacian/Quadratic based graph entropy. According to an embodiment, the graph distance is one of a Laplacian Matrix based graph distance, a Quadratic Matrix based graph distance, and a feature-based Laplacian/Quadratic based graph distance. According to an embodiment, the entropy of the new graph, the graph distance and the number of edges and/or nodes are each defined as differential values.

According to an embodiment, the method further includes combining or merging the approximated graph with a minimal graph to produce a returned graph, wherein the returned graph has the connectivity of the minimal graph and properties of the approximated graph.

According to an embodiment, the method further includes expanding the original graph.

According to an embodiment, a system for graph approximation is provided that includes one or more processors, and a memory storing code, which when executed by the one or more processors, cause the one or more processors to implement one of the above graph approximation methods or other method as described herein.

According to an embodiment, a non-transitory, computer-readable medium having instructions stored thereon which, upon execution by one or more processors, provide for execution one of the above graph approximation methods or other method as described herein.

The graph approximation and sparsification methods herein are useful in a wide variety of fields and applications, including, for example, the following applications and fields:

Multi Task Learning

Machine Learning Regression with Graph Smoothing

Fingerprint matching

Flu prevention

Cyber security

Biology and chemistry

Solutions of large linear systems

Neural Network computation graph reduction

Network Visualization

Graph Databases

According to an embodiment, the problem of graph sparsification may be formulated as an optimization problem. A cost function may be defined that measures the distance between the original graph and the target graph and has at least two components. The first component is the actual distance between the original graph and the target graph, for example, the distance may be 0 when the new (target) graph is the same as the original graph and increases as changes are applied relative to the original graph. A second component includes a term that measures the complexity of the new graph: this term may be composed of one or multiple terms, e.g., one or multiple values. An algorithm is also defined that, from an empty graph, adds edges in a manner that reduces the cost function, or from a full graph, removes edges in a manner that reduces the cost function.

FIG. 1 illustrates a graph approximation process according to an embodiment. In a first step, an original graph G is received. Original graph G may be received from another system, or created internally by another process running on the same system. For the matrix formulation processing step, an incident matrix is derived from original graph G. In an embodiment, optionally, graph G may be expanded. In a graph formulation step, the process iteratively: computes a gradient of the distance to the original graph and the entropy of the graph (e.g., matrix formulation of the graph) and selects one or more edges and/or one or more nodes based on the gradient so as to reduce the defined cost function. The result is the target graph. An optional graph completion step may be implemented to complete (connect) the final graph, e.g., to produce a final graph G′ as will be discussed below.

In an embodiment, the cost function includes: 1) an entropy of the new graph, 2) a graph distance (distance between the original graph and the new graph), and 3) a number of edges. The entropy of a graph provides a measure of the complexity of the graph. The entropy, in certain embodiments, includes a matrix based graph entropy such as a Laplacian Matrix based graph entropy, a Quadratic Matrix based graph entropy, and a Feature Laplacian/Quadratic based graph entropy. Similarly, in certain embodiments, the graph distance includes one or more of a Laplacian Matrix based graph distance, a Quadratic Matrix based graph distance, and a Feature Laplacian/Quadratic based graph distance.

In an embodiment, the various quantities (e.g., cost function, distance and entropy) may be defined as differential values.

In an embodiment, Von Neumann Graph Entropy is defined as:

$$Laplacian matrix L = D - A$$

$$Adjacent Matrix A = \{ {δ}_{( u , v ) ∈ E} \}$$

$$D = diag ( {d}_{1} , … , {d}_{n} )$$

$${d}_{i} = {\sum }_{j} {A}_{i j}$$

$$Density matrix ρ ( L ) = \frac{L}{t r ( L )} = \frac{L}{2 m}$$

Alternatively, Von Neumann Graph Entropy may be defined as:

$$Normalized Laplacian matrix {L}^{′} = {D}^{- \frac{1}{2}} L {D}^{- \frac{1}{2}}$$

Also, the density matrix may be defined as:

$$ρ ( {L}^{′} ) = \frac{{L}^{′}}{t r ( {L}^{′} )} = \frac{{L}^{′}}{n}$$

From the density matrix, the un-normalized Von Neumann entropy is defined as:

S(ρ)=−tr(ρ log ρ−ρ)

When

tr(ρ)=1

Then, the normalized Von Neumann entropy is:

S(ρ)=−tr(ρ log ρ)

If there are features on the nodes, the following may be included in the definition of the density:

σ′=X^{T}σX

In an embodiment, additional quantities may be defined as follows:

$$\begin{matrix}S ( ρ \vert \vert σ ) = t r ( ρ ( log ρ - log σ ) ) \\ = t r ( ρlogρ ) - t r ( ρlogσ ) \\ = - S ( ρ ) + S ( ρ , σ )\end{matrix}$$

$$\begin{matrix}S ( σ ) + β S ( ρ \vert \vert σ ) = - t r ( σ log σ ) + β t r ( ρ ( log ρ - log σ ) ) \\ = - β S ( ρ ) + S ( σ ) + β S ( ρ , σ ) \\ = - t r ( σ log σ ) + β t r ( ρ log ρ ) - β t r ( ρ log σ ) \\ = β tr ( ρ log ρ ) - t r ( ( σ + β ρ ) log σ )\end{matrix}$$

$$\begin{matrix}β S ( σ ) + S ( ρ \vert \vert σ ) = - β tr ( σ log σ ) + t r ( ρ ( log ρ - log σ ) ) ) \\ = - S ( ρ ) + β S ( σ ) + S ( ρ , σ ) \\ = - β tr ( σ log σ ) ) ) + t r ( ρ ( log ρ ) - β t r ( ρ log σ ) ) ) \\ = t r ( ρ log ρ ) - t r ( ( β σ + ρ ) log σ )\end{matrix}$$

In an embodiment, Quadratic entropy can also be used, where

S(σ)=tr(σ^{T}σ)

with the associated quantities

S(σ,ρ)=tr(σ^{T}ρ)

S(σ∥ρ)=tr(σ^{T}ρ)−tr(σ^{T}σ)

In an embodiment, Jensen Shannon Divergence may be used, where, derived from the same entropy definition, it is possible to define

$${S}_{J S} ( ρ \vert \vert σ ) = S ( \frac{ρ + σ}{2} ) - \frac{1}{2} S ( ρ ) - \frac{1}{2} S ( σ )$$

adding the entropy term

$$\begin{matrix}β - JSD ( ρ , σ ) = S ( σ ) + β JSD ( ρ , σ ) \\ = β S ( \frac{ρ + σ}{2} ) + ( β - \frac{1}{2} ) S ( ρ ) - β \frac{1}{2} S ( σ )\end{matrix}$$

For numerical stability a self-loop may be added for all nodes, which implies to define this modified un-normalized Entropy as

S(σ)=tr((σ+I)ln(σ+I)−σ)

which has associated the following quantities:

S(σ,ρ)==tr((σ+I)ln(ρ+I)−σ+ρ)

S(σ∥ρ)=tr((σ+I)ln(ρ+I))−tr((σ+I)ln(σ+I))

### Laplacian Matrix Format

In an embodiment, the Laplacian matrix L is defined by the incident matrix E. The incident matrix E is of size N×M and each column is a vector of zero, except for the start node +1 and end node −1:

σ=E diag(w)E^{T}=EWE^{T}

where w is the selector vector of +1 and 0. If +1, the edge is active, if 0, the edge is inactive. This definition allows to select the single edge. The nodes may be selected directly.

### Gradient

In an embodiment, the gradient of the normalized entropy may be written as:

∂_{σ}S(σ)=−ln σ^{T}−I

∂_{w}S(σ)=−diag(E^{T} ln EWE^{T}E)−1

∂_{w}S(EWE^{T})=−diag(E^{T} ln EWE^{T}E)−1

which gives the gradient of the distance as:

$$\begin{matrix}{\partial }_{w} JSD ( ρ , σ ) = {\partial }_{w} JSD ( E , w ) \\ = - \frac{1}{2} [ diag ( {E}^{T} ln E \frac{W + I}{2} {E}^{T} E ) - \\ diag ( {E}^{T} ln E W {E}^{T} E ) ] \\ = - \frac{1}{2} [ diag ( {E}^{T} ( ln E \frac{W + I}{2} {E}^{T} - ln E W {E}^{T} ) E ) ]\end{matrix} \qquad \begin{matrix}\begin{matrix}\begin{matrix}( 23 ) \\ ( 24 )\end{matrix} \\ \end{matrix} \\ ( 25 )\end{matrix}$$

or:

$$\begin{matrix}{\partial }_{w} β - JSD ( ρ , σ ) = β {\partial }_{w} S ( \frac{ρ + σ}{2} ) + ( β - \frac{1}{2} ) {\partial }_{w} S ( ρ ) \\ = \frac{β}{2} [ diag ( {E}^{T} ln E \frac{W + I}{2} {E}^{T} E ) - diag ( E {E}^{T} ) ] + \\ ( β - \frac{1}{2} ) [ diag ( {E}^{T} ln E W {E}^{T} E ) - diag ( E {E}^{T} ) ] \\ = diag ( {E}^{T} ( \frac{β}{2} ln E ( \frac{W + I}{2} ) {E}^{T} - \\ ( β - \frac{1}{2} ) ln {EWE}^{T} ) E \text{?} ( \frac{1}{2} - \frac{3}{2} β ) diag ( E {E}^{T} )\end{matrix} \\ \text{?} \text{indicates text missing or illegible when filed} \qquad \begin{matrix}\begin{matrix}\begin{matrix}\begin{matrix}\begin{matrix}\begin{matrix}\begin{matrix}\begin{matrix}( 32 ) \\ \end{matrix} \\ ( 33 )\end{matrix} \\ \end{matrix} \\ ( 34 )\end{matrix} \\ \end{matrix} \\ ( 35 )\end{matrix} \\ \end{matrix} \\ ( 36 )\end{matrix}$$

or un-normalized entropy as:

$$\begin{matrix} {\partial }_{w} JSD ( ρ , σ ) = {\partial }_{w} JSD ( E , w ) \\ = - \frac{1}{2} [ diag ( {E}^{T} ln ( E \frac{W + I}{2} {E}^{T} + I ) E ) - \\ diag ( {E}^{T} ln ( E W {E}^{T} + I ) \text{?} \\ = - \frac{1}{2} [ diag ( {E}^{T} ( ln ( E \frac{W + I}{2} {E}^{T} + I ) - \\ ln ( E W {E}^{T} + I ) ) E )\end{matrix} \\ \text{?} \text{indicates text missing or illegible when filed} \qquad \begin{matrix}\begin{matrix}\begin{matrix}\begin{matrix}\begin{matrix}\begin{matrix}( 40 ) \\ ( 41 )\end{matrix} \\ \end{matrix} \\ \end{matrix} \\ ( 42 )\end{matrix} \\ \end{matrix} \\ \end{matrix}$$

The gradient of the quadratic entropy is constant:

$$\begin{matrix}{\partial }_{w} JSD ( ρ , σ ) = {\partial }_{w} JSD ( E , w ) \\ = \frac{1}{2} diag ( {E}^{T} E {E}^{T} E ) - \frac{1}{4} diag ( {E}^{T} E )\end{matrix}$$

### Approximation

In an embodiment, the entropy is approximated; the gradient can be approximated using the following approximation of the logarithm:

ln(I+EWE^{T})≈EWE^{T}−EWE^{T}EWE^{T}/2+EWE^{T}EWE^{T}EWE^{T}/3+O((EWE^{T})⁴)

### Method Example

In an embodiment, an approximation algorithm may be written as:

$$\begin{matrix}i = arg {min}_{i} {\partial }_{w} ( E , w ) \\ = arg {min}_{i} - diag ( {E}^{T} ln \frac{1}{2} ( E {E}^{T} + E {W}_{i} {E}^{T} ) E ) + \\ \frac{1}{2} diag ( {E}^{T} ln E {W}_{i} {E}^{T} \text{?} \\ = arg {min}_{i} - diag ( {E}^{T} ( ln E \frac{W + I}{2} {E}^{T} - ln E W {E}^{T} ) E ) \\ = arg {max}_{i} - diag ( {E}^{T} ( ln E \frac{W + I}{2} {E}^{T} - ln E W {E}^{T} ) E )\end{matrix} \\ where \\ {W}_{i} = W + diag ( {e}_{i} ) \\ and \\ {e}_{i} = 1 , {e}_{j} = 0 , ∀ j \neq i \\ \text{?} \text{indicates text missing or illegible when filed} \qquad \begin{matrix}\begin{matrix}\begin{matrix}\begin{matrix}\begin{matrix}\begin{matrix}\begin{matrix}( 26 ) \\ \end{matrix} \\ ( 27 )\end{matrix} \\ \end{matrix} \\ \end{matrix} \\ ( 28 )\end{matrix} \\ \end{matrix} \\ ( 29 )\end{matrix}$$

or using the following flow:

```
Algorithm 1: σ ← Sparsifier(ρ)
Result: σw
w ← 0;
while not converged do
  gw ← ∂w D(ρ,σ);
  i* = arg mini gw (i);
  w(i*) = 1;
end
```

where the graph is grown from the zero graph. Alternatively, one can start from a full graph and remove edges, e.g., using the following algorithm:

```
Algorithm 2: σ ← Sparsifier(ρ)
Result: σw
w ← 1;
while not converged do
  gw ← ∂wD(ρ,σw);
  i* = arg maxi gw (i);
  w(i*) = 0;
end
```

Alternatively, one can update and use w to define the probability that an edge belongs to the new graph, and project the probability in the range [0, 1] and then select a realization of this probability as a final graph.

### Initial Graph

According to an embodiment, the basic method may start from the empty graph and add one edge at time, but this requires many iterations. Accordingly, in an embodiment, processing starts from an initial graph, e.g., MST, Effective Resistance, or METIS.

Since the optimal graph for beta->0 is a star graph (G(1,k−1)) where all nodes are connected to one node, one may start from this graph. To find the proper graph, heuristics may be used in certain embodiments:

1) Randomly select a node and a subset of nodes and compute the cost function for each of the selections and select the best;

2) Full search for all nodes by growing the star graph at each node but only proceeding with the minimum cost graph;

3) Search all possibilities (this may have polynomial complexity).

### Alternative Selection Mechanism

Based on the same cost function, in an embodiment, the process may use:

1) Sequential selection, where given a previous selection, an edge that reduces or minimizes the cost function is selected;

2) Genetic algorithm where the variables are the selection of the edges and the fit function is the cost of distortion of the graph; or

3) Random selection: in this case the edge(s) or node(s) are randomly selected and removed, where the probability of being picked up or the criteria for removing is based on the defined cost function.

### Node Selection Mechanism

In an embodiment, one way to select a node directly includes using a node selector, v, and its diagonal version, where the Lagrangian matrix may be modified as follows:

σ=diag(v)E diag(w)E^{T} diag(v)=VEWE^{T}V=VL_{w}V

The optimization can be extended based on the new variable v.

### Graph Completion

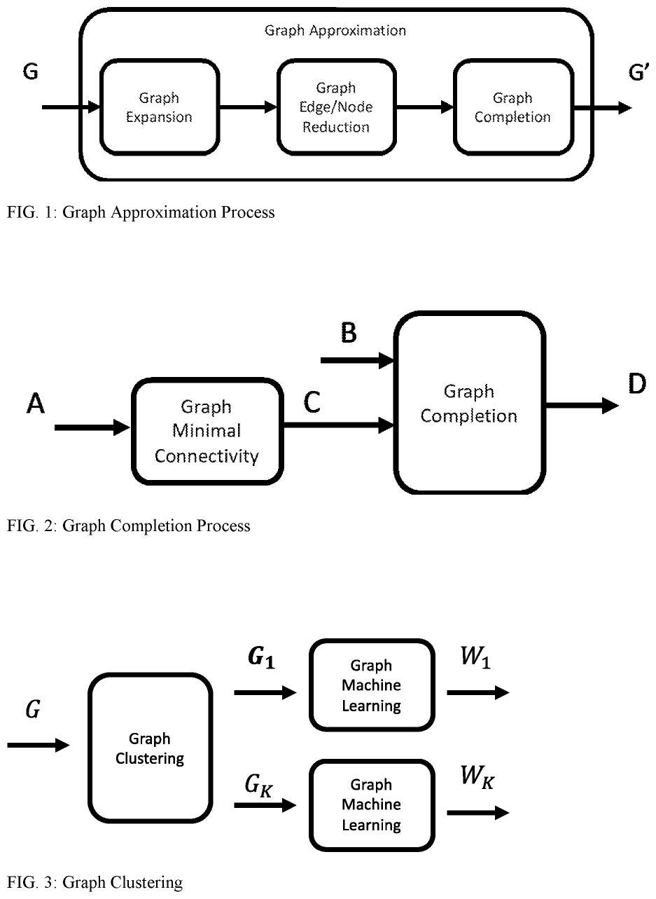

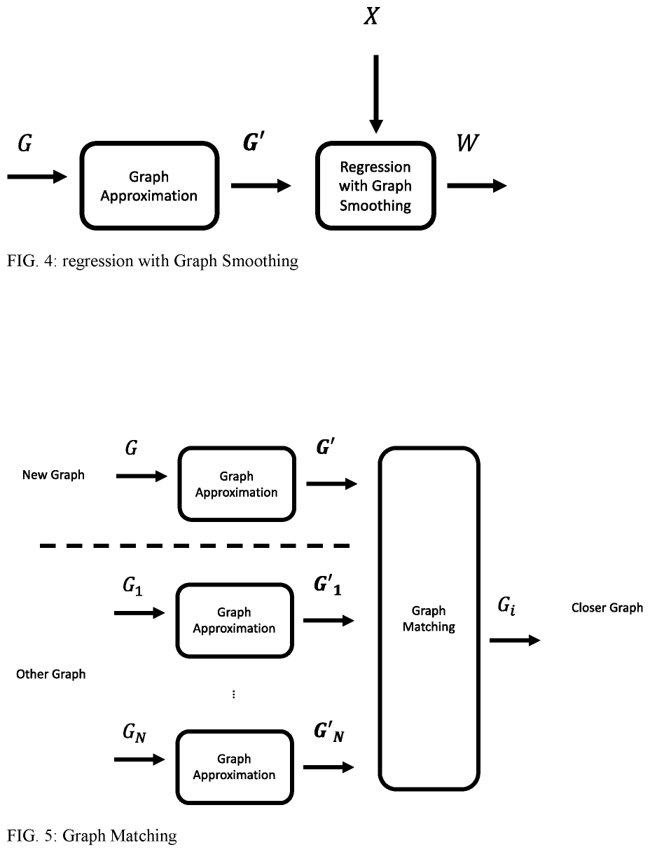

After creation of the sparsified/approximated version of the graph, graph completion may be implemented in an embodiment. FIG. 2 illustrates a graph completion process according to an embodiment. The method described provides a final graph which may be disconnected or lose other properties (e.g. presence of specific clique). The integration with MST graph (or any minimal connected graph) is considered by completing the connected components of the new graph with the edges of MST, which do not belong to the connected components. In this way, the graph is reconnected as the original graph. In FIG. 2, for example, B is the approximated graph of the original graph A, while C is a minimal graph (e.g., as MST), and in the graph completion step the two graphs B and C are combined, giving priority to graph B, such that the returned graph D has mainly the properties of B (e.g., distance and entropy of B), plus the connectivity of C, where connectivity means that if two nodes of the original graph are connected (i.e., reachable by a sequence of edges with shared nodes) then they are also connected in the final graph.

### Graph Expansion

In an embodiment, an initial step includes expanding the initial graph such that the following phase has more options for the graph approximation. The expansion step may be random, where two nodes not previously connected are connected either randomly or based on some similarity of their features (e.g., number of neighbors, data associated, embedding learned, etc.) as would be apparent to one skilled in the art.

### Use Applications

The present embodiments, and variations thereof, may be implemented in a variety of applications. Examples of use applications include the following: Graph Clustering for Machine Learning Tasks

FIG. 3 illustrates a graph clustering process according to an embodiment. In graph clustering, the problem of generating multiple sub-graphs Gk=G(Vk,Ek) such that the union of the sub-graphs recreate the original graph G=G(V,E) is considered:

$$G = {⋃}_{k = 1}^{K} {G}_{k}$$

The following problem is considered:

$${min}_{{w}_{k} ∈ {\{ 0 , 1 \}}^{m \times 1} , k ∈ [ K ]} {\sum }_{k = 1 , … , K} β - JSD ( L , E diag ( {w}_{k} ) {E}^{T} )$$

$$s . t . {w}_{k}^{T} {w}_{{k}^{′}} = 0 , ∀ k \neq {k}^{′}$$

$${\sum }_{k ∈ [ K ]} {w}_{k} = {1}_{m}$$

where the selection vector wk is used to assign edge to cluster. One can use a node selection vector to obtain an alternative clustering, where vk represents the node selector for partition k:

$${min}_{{v}_{k} ∈ {\{ 0 , 1 \}}^{n \times 1} , k ∈ [ K ]} {\sum }_{k = 1 , … , K} β - JSD ( L , diag ( {v}_{k} ) {L}_{w} diag ( {v}_{k} ) )$$

$$s . t . {v}_{k}^{T} {v}_{{k}^{′}} = 0 , ∀ k \neq {k}^{′}$$

$${\sum }_{k ∈ [ K ]} {v}_{k} = {1}_{n}$$

Regression with graph Smoothing

FIG. 1 illustrates an embodiment of Regression with Graph Smoothing according to an embodiment. When there is data associated to each node of a graph G with a Lagrangian matrix L, one is interested in computing the regression model w of:

$${min}_{w} {‖ Xw - y ‖}^{2} + λ t r ( {X}^{T} {L}^{- 1} X )$$

where xi, yi is the data sample on node i. Here one is interested in simplifying the graph G to reduce complexity and for improving generalization performance.

Image Retrieval

In image retrieval, for each image a set of local features may be extracted considering image characteristics around a point, as for example with SIFT (Scale-Invariant Feature Transform) or other feature detection mechanism (e.g., SURF, FAST, BRIEF, ORB). This generates a graph of features for each image. The problem becomes to re-identify a part of the feature in other images. One can use graph sparsification to generate a simpler version of the original feature graph that may be used for graph matching and image re-identification.

Flu/Epidemical Prevention

Graph simplification may also be used to detect relevant links when dealing with epidemical diffusion and being able to reduce the contamination network is critical for contamination control. The Graph simplification can be used to define where to deliver information.

Solving Large Scale Linear Systems

An important class of algorithms for solving large scale linear systems, at the core of many real world problems, is to simplify the equations and provide a sequence of approximated solutions that improves over iterations. Graph sparsification is a key component of such methods.

Finger Print Identification

For Finger print identification a set of local features is created and a graph is built on top of each of these local features. The problem is to compare this graph with the collection of existing finder graphs and detect if a feature may belong or not to any of the existing graphs. FIG. 5 illustrates an embodiment of graph matching according to an embodiment. Graph sparsification is an important function to reduce complexity in the graph matching phase and to increase accuracy.

Multi Task Learning

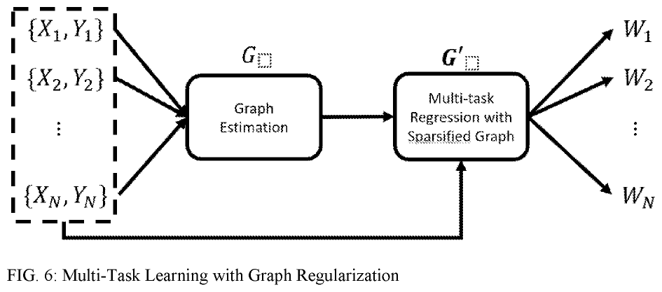

FIG. 6 illustrates an embodiment of Multi-task Learning with a Graph Regularization. In multi-task learning, one is given a group of N tasks, where each task is characterized by its input x and output y. It is desirable to learn the regression coefficient for N tasks (denoted as w₁, w₂, . . . , w_{N}) simultaneously by incorporating the relatedness amongst these tasks. Graph is a common way to establish the relationship between multiple tasks. If two tasks are related to each other, there is an edge to connect them. A larger weight in an edge indicates a stronger relationship. Mathematically, the objective for multi-task learning based on graph can be formulated as:

$${min}_{\{ {w}_{1} {w}_{2} … {w}_{N} \}} \frac{1}{2} {\sum }_{t = 1}^{N} {‖ {w}_{N}^{T} {x}_{N} - {y}_{N} ‖}_{2}^{2} + \frac{λ}{2} {\sum }_{i , j ∈ G} {‖ {w}_{i} - {w}_{j} ‖}_{2}$$

One is interested in simplifying the graph G to reduce complexity and for improving generalization performance.

Chemistry and Biology Graph Matching

In Chemistry and Biology, complex structures may be represented as graphs of basic elements. Based on these graphs, it is possible to estimate potential unknown interaction(s) among composites based on graph completion and graph comparison. Graph simplification may be used for improved performance in terms of computational cost or higher generalization.

Structural Reducibility

Many natural phenomenal, including protein-protein interactions, can be represented as a multilayered complex system. The reduction of these multilayer graphs is desirable and may be used to distinguish among networks.

Graph CNN

Another class of application is the possibility to reduce the size and at the same time to improve generalization performance of a Graph Convolutional Neural Network.

Graph Node Similarity

One application is to simplify the graph and apply GCN and compare the node similarity in the two versions.

Page Rank (Markov Model)

The use of an approximated graph can be used for Page Rank based systems, where the original graph is substituted by one or more graphs.

Cyber Security

The identification of critical edges in a communication network is important to guarantee the security of the network and safety services that rely on the network. Monitoring is costly and the possibility to simplify the network is important to concentrate resources in the more critical parts of the network. Graph simplification provides a way to define a network that represents the original network based on theoretical properties.

Network Visualization

Another important application is to visualize networks; graph simplification may be used to improve the understanding of what is happening in the network Neural Network computation graph reduction

Neural Network dropping is a critical element to improve generalization performance. The use of graph simplification provides a way to improve performance in terms of generalization and computational complexity.

Graph Database Systems

In graph databases, graph structures are stored and manipulated. Graph approximation provides a way to represent the Graph such that is easier to store, retrieve and compare graph structures.

The various embodiments herein provide various advantages, including one or more of the following:

1) An explicit definition of the cost function

2) A parametric cost function

3) A way to expand the initial graph

4) A way to guarantee connectivity

5) An efficient way to compute the gradient

6) An approximation of the gradient and the cost function

7) A theoretical justification of the distance of the graphs

### Example

A simple experiment was performed for Multi Task Learning (using CCMTL) on a school data set. This dataset is used to estimate examination scores of 15,362 students from 139 secondary schools in London from 1985 to 1987 where each school is treated as a task. The input consists of four school-specific and three student-specific attributes. First, a dense kNN (k=30) graph with approximately 2200 edges was built. The rooted mean square error of CCMTL is 10.118767.

The embodiments improve accuracy of the results at different sparsified graph sizes for Multi Task Learning (using CCMTL) as shown in the Table 1, below, where the following baselines are considered:

1) k-Nearest Neighbors

2) Random Sampling

3) Effective Resistance

4) The divergence function (von Neumann)

TABLE 1

| Final # of Edges | | | |
|---|---|---|---|
| (from 2′200) | ~700 | ~900 | ~1500 |
| kNN | 10.153828 | 10.142785 | 10.117327 |
| Effective Resistance | 10.176550 | 10.141106 | 10.121025 |
| Random Sampling | 10.167392 | 10.151106 | 10.105105 |
| von Neumann | 10.164717 | 10.139440 | 10.084138 |

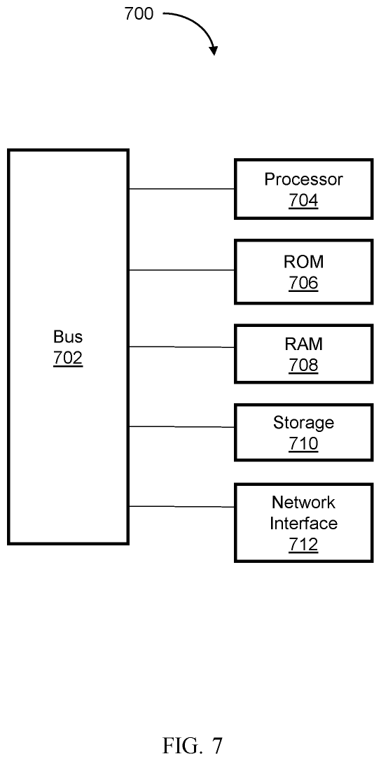

FIG. 7 is a block diagram of a processing system according to an embodiment. The processing system 700 can be used to implement the protocols, devices, mechanisms, systems and methods described above. The processing system 700 includes a processor 704, such as a central processing unit (CPU) of a computing device or a distributed processor system. The processor 704 executes processor-executable instructions for performing the functions and methods described above. In embodiments, the processor executable instructions are locally stored or remotely stored and accessed from a non-transitory computer readable medium, such as storage 710, which may be a hard drive, cloud storage, flash drive, etc. Read Only Memory (ROM) 706 includes processor-executable instructions for initializing the processor 704, while the random-access memory (RAM) 708 is the main memory for loading and processing instructions executed by the processor 704. The network interface 712 may connect to a wired network or cellular network and to a local area network or wide area network, such as the Internet, and may be used to receive and/or transmit data, including datasets such as datasets representing one or more images. In certain embodiments, multiple processors perform the functions of processor 704.

While embodiments have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for graph approximation, the method comprising:
computing an incident matrix based on an original graph;
defining a cost function of a new graph, the cost function including an entropy of the new graph, a graph distance and a number of edges and/or nodes, wherein the graph distance is a value representing a distance between the new graph and the original graph;
determining a reduced cost function by, iteratively:
computing a gradient of the cost function for the new graph, and
modifying the new graph by adding an edge to, or removing an edge from, the new graph; and
outputting an approximated graph, the approximated graph corresponding to the modified new graph having a minimum of the cost function.

2. The method of claim 1, wherein the new graph is initially defined as a zero graph.

3. The method of claim 2, wherein the modifying includes adding an edge to the new graph.

4. The method of claim 1, wherein the new graph is initially defined as the original graph.

5. The method of claim 4, wherein the modifying includes removing an edge from the new graph.

6. The method of claim 1, wherein the new graph is initially defined as one of a MST graph, an Effective Resistance graph and a METIS graph.

7. The method of claim 1, wherein the entropy of the new graph is one of a Laplacian Matrix based graph entropy, a Quadratic Matrix based graph entropy, and a feature-based Laplacian/Quadratic based graph entropy.

8. The method of claim 1, wherein the graph distance is one of a Laplacian Matrix based graph distance, a Quadratic Matrix based graph distance, and a feature-based Laplacian/Quadratic based graph distance.

9. The method of claim 5, wherein the entropy of the new graph, the graph distance and the number of edges and/or nodes are each defined as differential values.

10. The method of claim 1, further including combining or merging the approximated graph with a minimal graph to produce a returned graph, wherein the returned graph has the connectivity of the minimal graph and properties of the approximated graph.

11. The method of claim 1, further including expanding the original graph.

12. A system for graph approximation, the system comprising:
one or more processors; and
a memory storing code, which when executed by the one or more processors, cause the one or more processors to:
compute an incident matrix based on an original graph;
define a cost function of a new graph, the cost function including an entropy of the new graph, a graph distance and a number of edges and/or nodes, wherein the graph distance is a value representing a distance between the new graph and the original graph;
determine a reduced cost function by, iteratively:
computing a gradient of the cost function for the new graph, and
modifying the new graph by adding an edge to, or removing an edge from, the new graph; and
output an approximated graph, the approximated graph corresponding to the modified new graph having a minimum of the cost function.

13. The system of claim 12, wherein the code further causes the one or more processors to combine or merge the approximated graph with a minimal graph to produce a returned graph, wherein the returned graph has the connectivity of the minimal graph and properties of the approximated graph.

14. The system of claim 12, wherein the entropy of the new graph is one of a Laplacian Matrix based graph entropy, a Quadratic Matrix based graph entropy, and a feature-based Laplacian/Quadratic based graph entropy, and wherein the graph distance is one of a Laplacian Matrix based graph distance, a Quadratic Matrix based graph distance, and a feature-based Laplacian/Quadratic based graph distance.

15. A non-transitory, computer-readable medium having instructions stored thereon which, upon execution by one or more processors, provide for execution of a method comprising:
computing an incident matrix based on an original graph;
defining a cost function of a new graph, the cost function including an entropy of the new graph, a graph distance and a number of edges and/or nodes, wherein the graph distance is a value representing a distance between the new graph and the original graph;
determining a reduced cost function by, iteratively:
computing a gradient of the cost function for the new graph, and
modifying the new graph by adding an edge to, or removing an edge from, the new graph; and
outputting an approximated graph, the approximated graph corresponding to the modified new graph having a minimum of the cost function.
